(19) United States
(12) Patent Application Publication
(10) Pub. No.: US 2005/0230884 A1
(43) Pub. Date: Oct. 20, 2005

(54) Alumina ceramic and mehtod for its manufacture

(76) Inventors: Martin Josef Schallner, Ludwigsburg (DE); Andreas Felix Desire Opp, Stuttgart (DE); Ulrich Ernst Ewald Hoeppe, Backnang (DE)

Correspondence Address: KIRSCHSTEIN, OTTINGER, ISRAEL;& SCHIFFMILLER, P.C., 489 FIFTH AVENUE, NEW YORK, NY, 10017, US

(21) Appl. No.: 10/514,849

(22) PCT Filed: May 12, 2003
(86) PCT No.: PCT/IB03/02395

§ 371 Date: May 23, 2005

(30) Foreign Application Priority Data
May 15, 2002 (DE) P.10221866.8

(51) Int. Cl. C04B 35/10; C04B 35/478; C04B 33/32

(52) U.S. Cl. 264/662; 501/127; 501/134; 264/681

(57) ABSTRACT

A ceramic material made of alumina and titanium oxide, which is practically free from additives, achieves a high quality factor Q by annealing the material after sintering. Qualities of up to 17,900 at a measuring frequency of 10 GHz can be achieved.

Alumina ceramic and method for its manufacture The present invention relates to an alumina ceramic that is suitable for use as a dielectric material, in particular as a substrate material in RF and microwave technology, and to a method for manufacturing such a ceramic. Applications of such a ceramic material are e.g. impedance matching in microwave circuits, dielectric microwave resonators, microwave filters, microwave transmission lines, microwave capacitors, circuit boards for microwave circuits and the like. A ceramic material suitable for such applications should in particular have a low dielectric constant, a high quality factor Q in the microwave frequency range and, in general, a low temperature dependence of its dielectric properties.

The applicability of alumina-based ceramic for the above mentioned purposes has been examined in a plurality of patent publications. Pure alumina is an attractive material due to its low dielectric constant in the RF range. A disadvantage of alumina is the rather strong dependence of its permittivity from temperature of approx. 110 ppm/° C. This temperature dependence causes e.g. a temperature dependence of the Eigenfrequencies of microwave resonators based on such a material and thus restricts strongly the applicability of pure alumina as a dielectric in RF applications.

Therefore, a variety of alumina-based mixed ceramics have been examined for their usability in RF applications that contain, besides alumina, one or more additives that are to correct undesired properties of alumina. Various documents relate to mixed ceramics that contain titanium oxide TiO₂ besides other additives. Titanium oxide has a negative temperature coefficient TE of the permittivity, so that it is expected that by mixing alumina and titanium oxide in adequate proportions, it will be possible to produce a mixed ceramic having a low τ_{ε}.

However, it proves to be difficult to obtain ceramic materials with a quality factor Q sufficient for microwave applications by mixing only these two components. Therefore, the known alumina-titanium-oxide-mixed ceramics always contain further additives such as TaO₅ and SnO₂ in U.S. Pat. No. 4,866,016 and CaO and La₂O₃ in U.S. Pat. No. 4,668,646. U.S. Pat. No. 4,591,574 teaches the manufacture of a mixed ceramic material from the initial materials Al₂O₃, CaO and TiO₂ . According to this document, the TiO₂ is first processed with the CaO into calcium titanate separately from the Al₂O₃, and the calcium titanate is then mixed with the Al₂O₃ and sintered. I.e. in the material composition for sintering, TiO₂ is practically not contained any more. Calcium titanate has a much more strongly negative value of Te than that of TiO₂, so that small additions of this material are already sufficient in order to achieve a value of τ_{ε} close to zero for the mixed ceramic material. It is disadvantageous, however, that small fluctuations of the quantity of added calcium titanate or in the course of the sintering process cause τ_{ε} to differ noticeably from the desired value.

From U.S. Pat. No. 6,242,376 B1, a dielectric ceramic composition is known which comprises, besides alumina and titanium oxide, an addition of 0.1 to 3 weight percent Nb₂O₅. By sintering a mixture of these three initial materials during four hours at approx. 1,400° C., a ceramic material is obtained which has a temperature dependence τ_{f} of the resonance frequency between −30 and +30 ppm/° C. and is claimed to have qualities Q between 10,000 and 55,000. There are no specific indications as to the individual ceramic material compositions, the qualities Q obtained with these and the frequencies at which they were measured. It is only stated that measurements were carried out in the frequency range above 2 GHz, and from the statements concerning the measuring device, it can be concluded that the measurement frequency was not above 6 GHz. From the fact that the quality Q is generally inversely proportional to the frequency at which it is measured, and that the quality measurements were apparently not conducted at a fixed frequency but in a frequency range, it can be concluded that the highest Q values cited in this document, if they were in fact measured and did not only define the upper limit of an interval which contained the actually measured values, were obtained at low measurement frequencies. If one adopts as a measure for the suitability of a material for RF applications not the quality factor Q but the value of the product Q.f of quality factor and measuring frequency, which is largely independent from the measuring frequency, Q.f-factors of 110,000 at maximum, are obtained (for a measuring frequency in GHz).

Efforts to produce a ceramic material suitable for RF applications from a binary mixture of alumina and titanium oxide have up to now not led to satisfying results. Instead, from the article “Layered Al₂O₃-TiO₂ composite dielectric resonators with tuneable temperature coefficient for microwave applications”, N. Alford et. al., IEE proceedings-Science, measurement and technology, volume 147, no. 6, Nov. 2000, pages 269 to 73, a dielectric body has become known that has a structure composed of alternating layers of alumina and titanium oxide. Such a layered structure is expensive to manufacture and is therefore not suitable for mass production of moderately priced components.

From M. Ishitsuka, Synthesis and thermal stability of aluminium titanate solid solutions, J. Am. Ceram. Soc, volume 70, pages 69 to 71 (1987) it is known that at high temperatures aluminium titanate decomposes into alumina and titanium oxide.

The object of the present invention is to provide a ceramic material having an excellent quality and a low and selectively controllable temperature coefficient τ_{ε}, as well as a simple and economic procedure for its manufacture.

The object is achieved by a method according to claim 1 and a ceramic material according to claim 10.

The invention is based on the finding that unsatisfying qualities Q conventionally achieved with binary alumina-titanium-oxide-mixtures result from the formation of aluminium titanate during sintering of the raw components. While in the mixed alumina-titanium-oxide-ceramics of the prior art, the formation of aluminium titanate is apparently prevented from the beginning by suitable additives, the formation of aluminium titanate during sintering is voluntarily accepted according to the present invention, and instead, it is decomposed in the annealing phase after sintering. Surprisingly, in spite of the restructuration of the material associated with this decomposition, after annealing, high densities of the sintered body and excellent qualities Q are achieved.

Due to the decomposition of the aluminium titanate a posteriori by annealing, it is possible to avoid the use of sintering adjuvants. The finished ceramic is therefore very pure, it can contain 99.5% or more of Al₂O₃ and TiO₂.

The sintering temperature according to the invention is preferably between 1,390 and 1,450° C. It has been shown that with a given composition of the ceramic, the coefficient τ_{ε} may be influenced by an appropriate choice of the sintering temperature. In this way, from one and the same raw material mixture, ceramic bodies having different temperature coefficients τ_{ε} may be manufactured, and the temperature coefficient τ_{ε} may e.g. be chosen for a particular application such that the temperature coefficient of the ceramic material also compensates the temperature dependence of neighbouring components of a microwave circuit.

For decomposing the aluminium titanate, an annealing temperature below 1,280° C. is required; a speedy decomposition is achieved in a temperature interval between 1,000° C. and 1,200° C., preferably between 1,075° C. and 1,125° C.

The duration of the annealing phase of not more than five hours has proved sufficient for decreasing the aluminium titanate content of the ceramic material obtained by sintering below the detection limit of X-ray diffraction, i.e. below a proportion of approx. 1%.

Further features and advantages of the invention become apparent from the subsequent description of embodiments.

For the manufacture of samples of the ceramic material according to the invention, the following raw materials were used:

TABLE 1

| | Alumina | Titanium oxide |
|---|---|---|
| Purity | >99.9% | 99.9 + % |
| Crystallization | α-alumina | Rutile |
| type | | |
| Particle size | 0.3 μm | 1.17 μm |
| Si (ppm) | <40 | |
| Na (ppm) | <10 | |
| Mg (ppm) | <10 | |
| Cu (ppm) | <10 | |
| Fe (ppm) | <20 | |
| Surface according | 5-10 m2/g | |
| to BET | | |

The raw materials were mixed in the following proportions:

TABLE 2

| | Alumina | Titanium oxide |
|---|---|---|
| Mixture | [mol %] | [mol %] |
| 1 | 89 | 11 |
| 2 | 90 | 10 |
| 3 | 91.5 | 8.5 |
| 4 | 93 | 7 |

In order to achieve homogeneity and to destroy powder agglomerates, 200 g of each of the mixtures defined in table 2 were mixed in an attritor (Netsch, PE-cup, zirconia grinding tool and 2 mm balls) with 130 g of purified water added, for twenty minutes at 800 revolutions per minute. A strong milling effect is not to be expected due to the refinement of the used powders and is also not necessary.

After finishing the kneading process, 2 to 2.5 weight percent of organic additives containing binder, plastifier, lubricants and form adjuvants were added to the obtained slurry.

After mixing, the slurry was reduced to a ready to press granulate in a laboratory spray dryer (Büchi 190, 0.7 mm nozzle, 190° C. inlet temperature, 115° C. outlet temperature). This granulate was pressed in a metal mold having 11 mm in diameter to green bodies with a height of 8 mm under a pressure of 1,500 kg/cm².

The subsequent sintering of the shaped bodies began with a step of heating to up to 550° C. in order burn out all organic additives. Subsequently, the temperature was increased at a rather high rate of 8 K/min to the sintering temperature. Tests were carried out with sintering temperatures between 1,400 and 1,475° C. After three hours of sintering, the temperature was decreased at a rate of 6 K/min to 1,100° C., and a three hours annealing step at this temperature followed. Afterwards, the samples were cooled to room temperature.

The complete thermal processing was carried out in a pure oxygen atmosphere.

In order to remove surface impurities caused by the sintering process and to bring all samples into identical dimensions for the subsequent measurements, the finished sintered bodies were ground to a diameter of 7.5 mm±0.01 mm and a height of 5 mm±0.01 mm. After grinding, the samples were cleaned and stored at normal atmospheric conditions.

Measuring Conditions

The microwave measurements were carried out in the −50° C. to 120° C. temperature range by a resonant cavity method using the TE_{01δ} mode. The sintered bodies were placed in a cylindrical, gold plated copper cavity (diameter: 25.02 mm, height: 15.02 mm) on a 5 mm high, low loss sapphire spacer. Under the cited conditions, the resonance frequency fᵣ, the quality Q, the relative permittivity εᵣ and the temperature coefficient of the permittivity τ_{ε} were measured. The influence of the resistance of the cavity wall surface on the measured quality factor Q of the sintered body was taken into account and corrected.

Results of Measurements

Result of a first test series carried out with sintered bodies manufactured under identical thermal processing conditions are shown in subsequent table 3.

TABLE 3

| | Sintering | Annealing | | | |
|---|---|---|---|---|---|
| Mixture | temperature | temperature | εᵣ | τ_{ε} | Q |
| 1 | 1.375 | 1.100/ | 11.40 | −44.47 | 15.900 |
| | | 3 h | | | |
| 2 | 1.375 | 1.100/ | 11.36 | −16.24 | 17.900 |
| | | 3 h | | | |
| 3 | 1.375 | 1.100/ | 11.17 | −2.19 | 17.300 |
| | | 3 h | | | |
| 4 | 1.375 | 1.100/ | 10.97 | 32.17 | 13.500 |
| | | 3 h | | | |

The indicated amounts of the quality factor Q relate to a measuring frequency of 10 GHz and a measuring temperature of 40° C.

The temperature coefficient TE may be set to positive and to negative values by selecting the composition of the raw mixture. Small, non-vanishing values of the temperature coefficient τ_{ε} in the shown range can be desirable in order to compensate the temperature dependence of adjacent circuit components by the temperature dependence of the ceramic material, so as to obtain as small as possible a temperature dependence of the behaviour of a complete circuit manufactured using the ceramic material of the invention. The measured quality factors Q correspond to Q.f factors of 130,00 to 179,000.

In a second test series, green bodies of mixture 2 were sintered at different temperatures. The other conditions of the thermal processing were the same as in the first test series. The obtained results are given in table 4.

TABLE 4

| | Sintering | Annealing | | | |
|---|---|---|---|---|---|
| Mixture | temperature | temperature | εᵣ | τ_{ε} | Q |
| 2 | 1.450 | 1.100/ | 11.36 | −34.67 | 11.500 |
| | | 3 h | | | |
| 2 | 1.440 | 1.100/ | 11.36 | −30.38 | 12.500 |
| | | 3 h | | | |
| 2 | 1.430 | 1.100/ | 11.36 | −27.77 | 14.200 |
| | | 3 h | | | |
| 2 | 1.420 | 1.100/ | 11.36 | −23.23 | 14.500 |
| | | 3 h | | | |
| 2 | 1.410 | 1.100/ | 11.35 | −21.87 | 15.600 |
| | | 3 h | | | |
| 2 | 1.400 | 1.100/ | 11.35 | −20.15 | 15.500 |
| | | 3 h | | | |

As the table shows, the sintering temperature also has an influence on the temperature coefficient τ_{ε} of the dielectric constant.

It is readily apparent that a modification of the composition of the mixture has a stronger effect on the dielectric properties of the sintered bodies than the sintering temperature. An adaptation of the sintering temperature might therefore be helpful for “fine tuning” the desired temperature coefficient τ_{ε} after coarsely defining it by the material composition.

It is to be assumed that similar results as given above for mixture of alumina and titanium oxide can be achieved if the titanium oxide is replaced by an earth alkali titanate such as CaTiO₃ or SrTiO₃ or a mixture of one or more earth alkali titanates and/or titanium oxide. CaTiO₃ and SrTiO₃ have a much more strongly negative temperature coefficient τ_{ε} than TiO₂. Therefore, when using these materials, smaller proportions of titaniferous oxide in the mixture may be sufficient to obtain a temperature compensation in a desired extent than when using pure titanium oxide. However, it is to be expected that when using earth alkali titanates, precisely due to the strong temperature dependence of it τ_{ε}, the properties of the finished sintered bodies will depend more strongly from small variations of the chemical composition or the sintering conditions than with the above described examples, so that exact control of the dielectric properties of the ceramic material may become more difficult.

1-14. (canceled)

15. A method of manufacturing alumina ceramic, comprising the steps of: sintering a mixture containing alumina powder and titaniferous oxide powder into a ceramic body; and annealing the ceramic body at an annealing temperature below 1,280° C.

16. The method of claim 15, and selecting the titaniferous oxide powder from one of titanium oxide, an earth alkali titanate, and a mixture of titanium oxide and at least one earth alkali titanate.

17. The method of claim 15, and selecting the titaniferous oxide powder from pure titanium dioxide.

18. The method of claim 15, wherein the sintering is performed at a temperature between 1,300° C. and 1,500° C., preferably between 1,350° C. and 1,450° C.

19. The method of claim 15, wherein the annealing is performed at the annealing temperature between 1,000° C. and 1,200° C., preferably between 1,075° C. and 1,125° C.

20. The method of claim 15, wherein the annealing is performed for a duration of at least one hour, preferably less than five hours.

21. The method of claim 15, wherein the annealing is performed until an aluminum titanate content of less than 2% is achieved.

22. The method of claim 15, wherein at least 99.9% of a mineral fraction of the mixture is formed of Al₂O₃ and TiO₂.

23. The method of claim 22, wherein the mineral fraction contains between 89 and 93 mol % of Al₂O₃ and between 7 and 11 mol % TiO₂.

24. An alumina-based ceramic material comprising: an alumina content between 89 and 93 mol %; a content of titaniferous oxide between 7 and 11 mol %; and a total content of alumina and titaniferous oxide of at least 99.95 mol % and a Qf-factor of at least 100,000.

25. The ceramic material of claim 24, wherein the titaniferous oxide is selected from a group including titanium dioxide, an earth alkali titanate, and a mixture of titanium dioxide and at least one earth alkali titanate.

26. The ceramic material of claim 24, wherein the titaniferous oxide is pure titanium dioxide.

27. The ceramic material of claim 26, wherein a maximum 2 mol %, preferably a maximum 1 mol %, of the alumina and the titanium dioxide is present in the form of aluminium titanate.

28. The ceramic material of claim 24, comprising a relative dielectric constant between 10.5 and 12.0, preferably between 10.9 and 11.6, and a temperature coefficient of relative permittivity between −60 ppm and +40 ppm.
